(19) United States
(12) Patent Application Publication
(10) Pub. No.: US 2014/0184997 A1
(43) Pub. Date: Jul. 3, 2014

(54) PREPOLYMER ORIENTATED FILM AND METHOD FOR PREPARING SAME, AND LIQUID DISPLAY DEVICE

(71) Applicants: BEIJING BOE DISPLAY TECHNOLOGY CO. LTD., Beijing (CN); BOE TECHNOLOGY GROUP CO., LTD., Beijing (CN)

(72) Inventors: Wei Yan, Beijing (CN); Dan Wang, Beijing (CN)

(21) Appl. No.: 13/704,149

(22) PCT Filed: Sep. 19, 2012
(86) PCT No.: PCT/CN2012/081578

§ 371 Date: Dec. 13, 2012

(30) Foreign Application Priority Data
Sep. 19, 2011 (CN) 201110278222.6

(51) Int. Cl. G02F 1/1337; G02F 1/1343

(52) U.S. Cl. CPC G02F 1/133723; G02F 1/134309
USPC 349/123; 548/457; 546/99; 524/876; 428/1.27

(57) ABSTRACT

Disclosed is a polyimide prepolymer, an alignment film and a method for preparing the same, as well as a liquid display device. The polyimide prepolymer has a repeating unit as shown in Formula (1) and is capped with a capping agent having a phenylethynyl group:

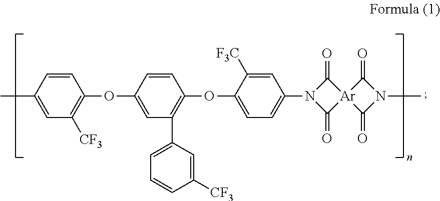

wherein Ar is selected from one of the structures of the following Formulae (2) and (3):

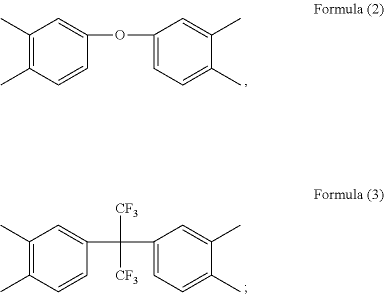

and n is an integer of between 3 and 8.

### TECHNICAL FIELD

The invention relates to a fluorine-containing polyimide prepolymer, an alignment film prepared from the fluorine-containing polyimide prepolymer, as well as a liquid crystal display device comprising the alignment film. The alignment film is especially suitable for a liquid crystal display device employing the ADS (Advanced Super Dimension Switch) display mode.

### BACKGROUND

In the past, liquid display devices employing the STN (Super Twisted Nematic) display mode have issues of small visual angles, color loss of the image when viewing from a large lateral angle, and poor contrast and color appearance. In order to solve this problem, a broad vision technique has been developed. In the technique of ADS, that is, Advanced Super Dimension Switch, a multi-dimensional electric filed is formed by the electric field generated from the edges of slit electrodes on the same plane and the electric field generated between the layer of slit electrodes and the layer of plate electrodes, which enable all oriented liquid crystal molecules on top of the electrodes and between the slit electrodes in the liquid crystal box to rotate, thereby improving the working efficiency of the liquid crystal and increases the efficiency of transmission. The advanced super dimension switch technique can improve the image quality of TFT-LCD products, and boasts advantages such as high resolution, high transmission, low power consumption, broad visual angle, high numerical aperture, low chromatic aberration, no push Mura and the like.

Orientation of the liquid crystal molecule alignment is one of the key issues in the production of liquid display devices. Rubbing orientation is one of the common orientation methods currently used in the manufacture of liquid display devices. For display mode employing the ADS technique, when rubbing orientation is used, it is desired that the liquid crystal molecule is arranged parallel to the rubbing direction and has a pretilt angle as low as possible, since in ADS display mode, the action of the liquid crystal molecules in the vertical direction has a huge effect on the transmissivity of the whole liquid crystal display device. Therefore, the choice of the alignment film becomes the key issue.

Among the materials used for producing the alignment film, the most common material is polyimide, which boasts the following advantages: 1) the film itself has the function to align the liquid crystal molecules, 2) it shows good orientation effect on all types of liquid crystals, 3) depending on the area of the substrate, means such as spin coating, roller coating, dip coating, spray coating, gravure coating and the like can be chosen as required, and it is possible to coat an even film on the surface of the substrate, and 4) the orientation effect is perfect which can pass the heat resistance test at 500° C. for 5 minutes. However, most of the current polyimide materials suitable for the STN display mode require large pretilt angle, rendering it not suitable for the ADS display mode.

Moreover, the existing polyimide alignment film also has the defect of being not solvent resistant. During the preparation and subsequent use of the liquid crystal display device, the orientation function is prone to lose gradually when attacked by the solvent, resulting in the failure of the liquid display device.

### SUMMARY

In light of the aforementioned issues, the inventors has conducted extensive researches and found that the introduction of fluorine atoms in the polyimide enables an effective control of the pretilt angle, thus completed the invention. That is, the invention provides a fluorine-containing polyimide prepolymer, an alignment film and a method for preparing the same, as well as a liquid display device. The alignment film made from the fluorine-containing polyimide prepolymer has good film-forming performance, mechanical properties and solvent resistance, enables the liquid crystal molecules to align better, and reduces the effect of the variation of the pretilt angle on the transmissivity of the liquid crystal display device, especially the effect on the transmissivity under the dark state.

Specifically, the invention provides the following technical solutions:

[1] A polyimide prepolymer, which has a repeating unit as shown in Formula (1) and is capped with a capping agent having a phenylethynyl group:

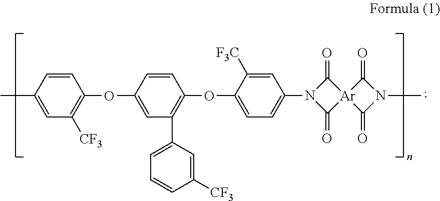

wherein Ar is selected from one of the structures of the following Formulae (2) and (3):

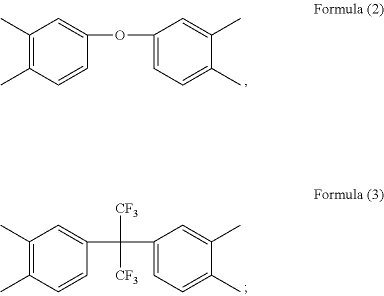

and n is an integer of between 3 and 8.

[2] The polyimide prepolymer according to [1], wherein the capping agent having a phenylethynyl group is 4-phenylethynyl-1,8-naphthalic anhydride.

[3] The polyimide prepolymer according to [1] or [2], wherein the polyimide prepolymer is:

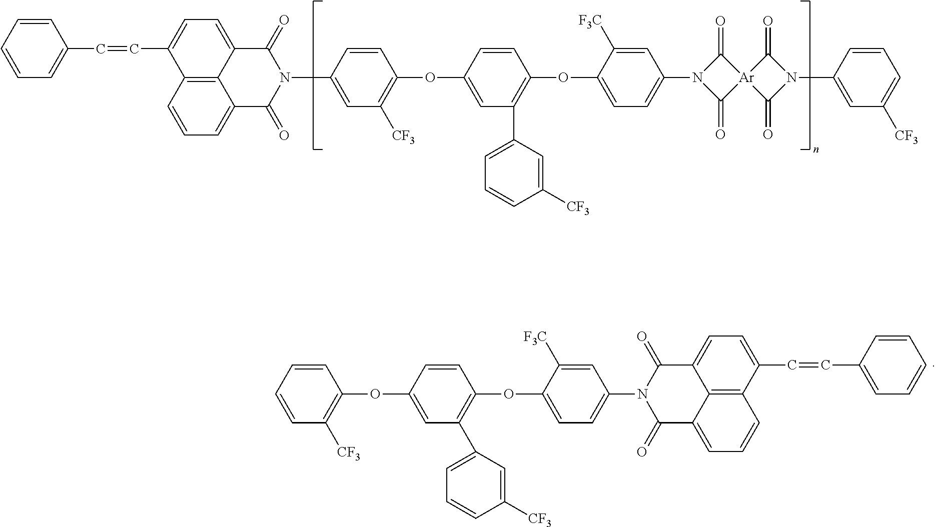

wherein Ar is selected from one of the structures of the Formulae (2) and (3), and n is 3, 5 or 8.

[4] The polyimide prepolymer according to any one of [1] to [3], wherein Ar is selected from the structure of the Formula (3).

[5] An alignment film comprising a polyimide prepolymer according to any one of [1] to [4].

[6] The alignment film according to [5], wherein it has a pretilt angle of between 0° and 2°.

[7] The alignment film according to [6], wherein it has a pretilt angle of between 0.5° and 1.5°.

[8] A method for preparing an alignment film, comprising the steps of:

1) dissolving a polyimide prepolymer according to any one of [1] to [4] in an organic solvent, agitating to be homogeneous, and then spreading the obtained solution onto a glass substrate, drying to remove the solvent so as to form a film; and

2) heating to a temperature of between 350° C. and 400° C. to cross-link phenylethynyl groups.

[9] A liquid crystal display device comprising a color film substrate and an array substrate, wherein the device comprises an alignment film according to any one of [5]˜[7].

[10] The liquid crystal display device according to [9], wherein a pixel electrode and a common electrode are disposed on the array substrate, wherein the pixel electrode and the common electrode are disposed in different layers of the array substrate, and an insulating layer is provided between the pixel electrode and the common electrode, the common electrode covers the whole pixel area, and the pixel electrode has a shape of a slit.

### Effect of the Invention

In the invention, fluorine atoms are introduced in the form of trifluoromethyl into a polyimide prepolymer for the preparation of an alignment film, and the number of the repeating units of the prepolymer is controlled. By doing this, the orientation and alignment effect of the alignment film on the liquid crystal molecules can be significantly improved, and the repulsive force between the dianhydride residues and the polar groups of the liquid crystal molecules can be reduced. The pretilt angle of the prepolymer of the invention is very small. The alignment film prepared from it can allow the liquid crystal molecules more prone to align along the rubbing direction. Moreover, the introduction of the phenylethynyl end group capable of cross-linking can further cross-link and cure the alignment film, increasing the chemical stability of the alignment film against the contacted substances (e.g., liquid crystal) and increasing its solvent resistance.

### BRIEF DESCRIPTION OF THE DRAWINGS

FIG. 1 is an infrared spectrum of the polyimide prepolymer I prepared in Embodiment 1.

FIG. 2 is an infrared spectrum of the polyimide prepolymer II prepared in Embodiment 2.

FIG. 3 is an infrared spectrum of the polyimide prepolymer III prepared in Embodiment 3.

FIG. 4 is an infrared spectrum of the polyimide prepolymer IV prepared in Embodiment 4.

### DETAILED DESCRIPTION

The prepolymer of the invention has a repeating unit formed from a specific diamine monomer having trifluoromethyl and an aromatic dianhydride monomer, and has phenylethynyl groups as end group. Specifically, the prepolymer of the invention has a repeating unit as shown in Formula (1) and is capped with a capping agent having a phenylethynyl group:

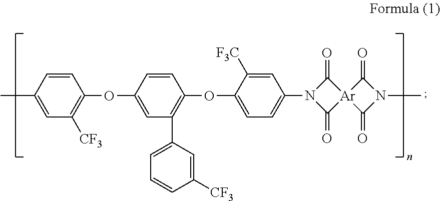

wherein Ar is selected from one of the structures of the following Formulae (2) and (3):

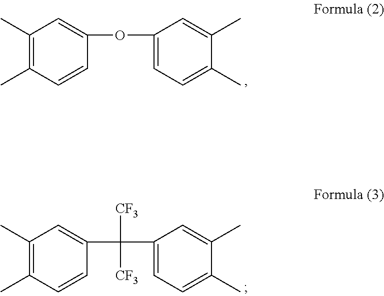

and n is an integer of between 3 and 8.

The diamine monomer having trifluoromethyl used in the invention is specifically 1,4-bis(4-amino-2-trifluoromethylphenyloxy)-2-(3′-trifluoromethylphenyl)benzene; the dianhydride monomer having the structure shown in Formula (2) used is 3,4,3′,4′-diphenyl ether tetracarboxylic acid dianhydride (ODPA), and the dianhydride monomer having the Ar portion of the structure as shown in Formula (3) is 2,2′-bis(3,4-dicarboxylbenzene)hexafluoropropane dianhydride (6FDA).

The inventor has found that, by introducing fluorine atoms in the form of trifluoromethyl and choosing suitable aromatic dianhydride monomers, as well as controlling the number of the repeating units of the polyimide prepolymer faulted, the orientation and alignment effect of the alignment film on the liquid crystal molecules can be significantly improved, the repulsive force between the dianhydride residues and the polar groups of the liquid crystal molecules can be reduced, and the pretilt angle can be reduced, so as to allow the liquid crystal molecules align more readily parallel to the surface of the alignment film. The aforementioned two specific dianhydride monomers have good reactivity with the aforementioned diamine monomer, and facilitate the preparation of the polyimide prepolymer.

In some embodiments according to the invention, the number of the repeating units of the polyimide prepolymer (n value) is preferably an integer of between 3 and 8, more preferably 3, 5 or 8. When n is more than or equals to 3, the repulsive force between the dianhydride residues in the prepolymer and the liquid crystal molecules can be significantly reduced, which greatly favors the orientation of the liquid crystal molecules. When n is less than or equals to 8, the film forming property of the prepolymer is the best, and the yield of the prepolymer is high.

In some embodiments according to the invention, the prepolymer is capped with a phenylethynyl group. If the prepolymer of the invention is not capped with the phenylethynyl group, this prepolymer is prone to dissolve into various solvents, resulting in a poor solvent resistance. As long as the capping agent used in the invention is a capping agent that can impart the phenylethynyl group to the end of the prepolymer of the invention, there is no specific limitation on it, but it is preferably 4-phenylethynyl-1,8-naphthalic anhydride shown in the following formula:

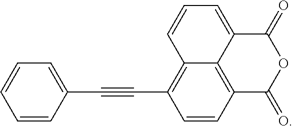 [SMILES: O=C1OC(=O)c2ccc(C#Cc3ccccc3)c3cccc1c23]

With 4-phenylethynyl-1,8-naphthalic anhydride used as the capping agent, the activity of the end capping reaction during the preparation of the prepolymer of the invention is higher, which improves the yield of the prepolymer.

Among the aforementioned dianhydrides, 2,2′-bis(3,4-dicarboxylbenzene)hexafluoropropane dianhydride (6FDA) is preferably used as the aromatic dianhydride monomer. This monomer has extra trifluoromethyl groups, and thus is conducive to a further decrease of the repulsive force between the dianhydride residues and the liquid crystal molecules.

In a particularly preferred embodiments, the prepolymer of the invention can be:

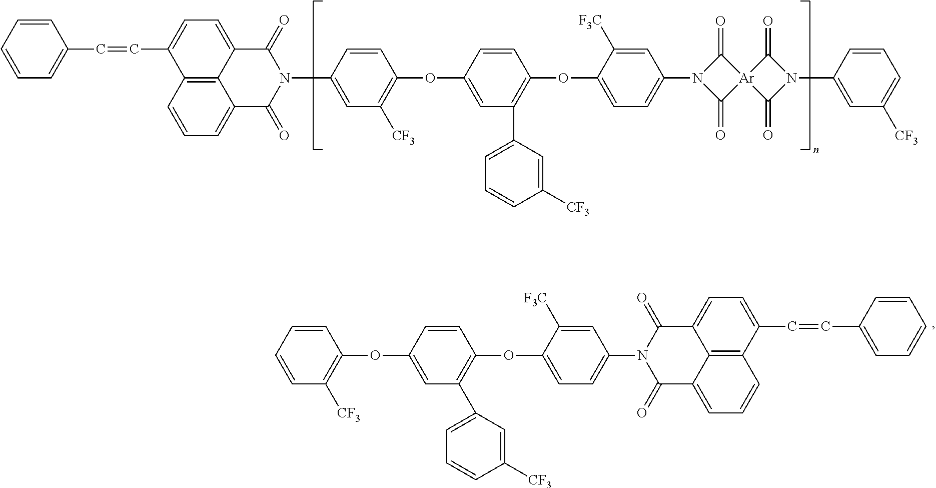

wherein Ar is selected from one of the structures as shown in Formulae (2) and Formula (3), and n is 3, 5 or 8. Furthermore, Ar is preferably the structure as shown in Formula (3).

The prepolymer of the invention can be prepared by common methods used for preparing polyimide. For example, it can be prepared through a one-step method. The scheme of the one-step method can be shown as follows:

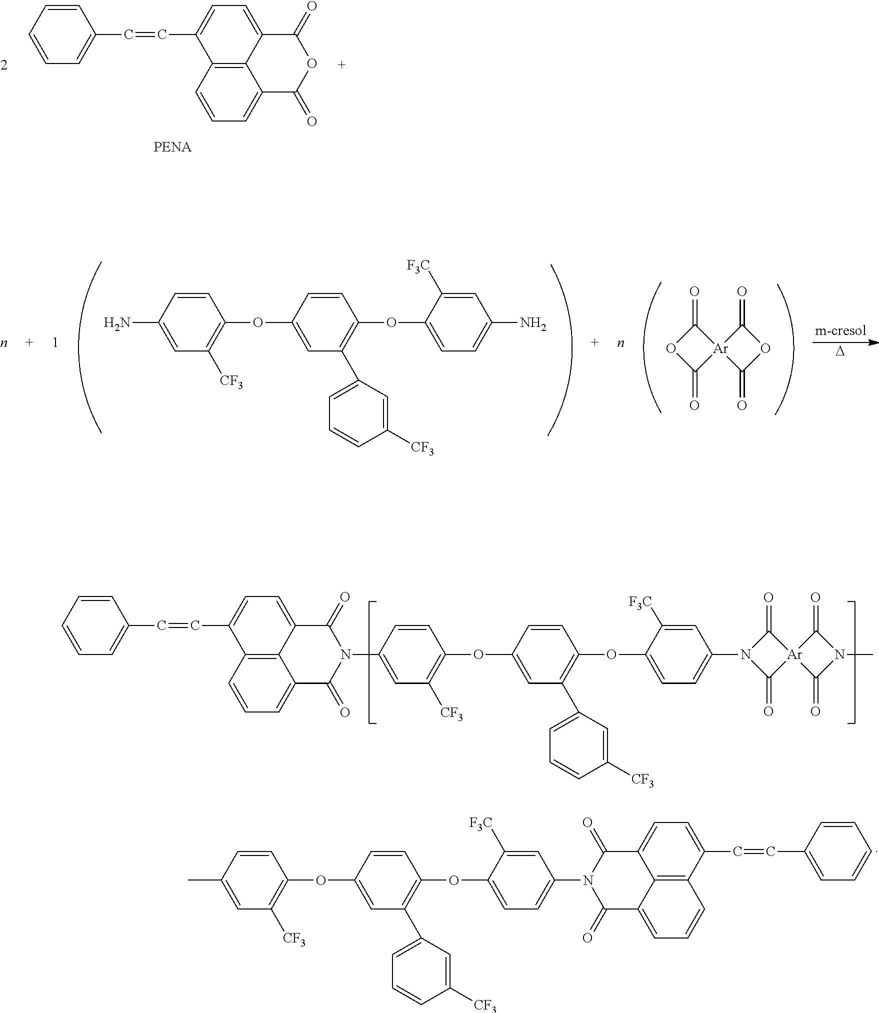

The one-step method is specifically as follows:

The aforementioned dianhydride monomer, the aforementioned diamine monomer and m-cresol are added into a flask with agitation and a reflux condensing pipe and subject to an agitation at room temperature under nitrogen gas for 8 to 12 hours. The number of the repeating units of the polyimide prepolymer generated is controlled by controlling the molar ratio among the raw materials added. Then the capping agent and xylene are added. The temperature is increased to allow the xylene to reflux with water for 3 to 4 hours. Subsequently, xylene is heated to evaporate out, followed by the addition of isoquinoline. The temperature is increased to 200° C. to continue the reaction for 8 to 10 hours. After the completion of the reaction, it is cooled to the room temperature and slowly decanted into ethanol under agitation, resulting in the prepolymer of the invention. It is washed and dried to obtain the finished product.

Moreover, the invention also provides an alignment film comprising the aforementioned prepolymer, which boasts the advantages of good solvent resisitance and high mechanical strength. Moreover, it has a small pretilt angle and is suitable for the liquid crystal display device in the ADS display mode.

Moreover, the invention also provides the method for preparing the aforementioned alignment film, comprising the steps of:

1) dissolving the aforementioned polyimide prepolymer in an organic solvent, agitating to be homogeneous, and then spreading the obtained solution onto a glass substrate, drying to remove the solvent so as to form a film; and

2) heating to a temperature of between 350° C. and 400° C. to cross-link phenylethynyl groups.

As long as the aforementioned organic solvent is an aprotic solvent with high boiling point, there is no special limitation. For example, N-methylpyrolidone, DMAc (N,N-dimethylacetamide), DMF (N,N-dimethylformamide) and the like can be used. The aforementioned coating method is not specifically limited, for example, it can be spin coating, roller coating, brush coating, scrape coating, dip coating, screen coating, spray coating, gravure coating, etc., and is preferably spin coating. The drying can be conducted in a vacuum oven by stepwise heating (60˜200° C.). The specific step of cross-linking the phenylethynyl groups can specifically be cross-linking at a temperature between 350° C. and 400V under vacuum for 2 hours.

Furthermore, the invention also provides a liquid crystal display device comprising the aforementioned alignment film. The liquid crystal display device may include end products such as liquid crystal panel, liquid crystal television, liquid crystal display element, digital frame, electronic paper, cell phone, etc. In particular, the alignment film is employed in ADS type display devices, which can significantly improve the orientation and alignment effect of the alignment film on the liquid crystal molecules and reduce the repulsive force between the dianhydride residues and the polar groups of the liquid crystal molecules. The prepolymer of the invention has a very small pretilt angle. When rubbing orientation is employed, the thus prepared alignment film can allow the liquid crystal molecules to more readily align along the rubbing direction. Moreover, the pretilt angle of the liquid crystal molecules is very small, resulting in a higher transmissivity and better display quality of the ADS type display device. The ADS type display device comprises a color film substrate and an array substrate, wherein a pixel electrode and a common electrode are disposed on the array substrate, wherein the pixel electrode and the common electrode are disposed in different layers of the array substrate, and an insulating layer is provided between the pixel electrode and the common electrode, the common electrode covers the whole pixel area, and the pixel electrode has a shape of a slit, and the device comprises any alignment film as mentioned above. Moreover, the introduction of the phenylethynyl end group capable of cross-linking can further cross-link and cure the alignment film, increase the chemical stability of the alignment film against the contacted substances (such as liquid crystals) and increase its solvent resistance.

### EXAMPLES

The invention is further illustrated via examples below. However, the scope of the invention to be protected is not limited to the following examples.

### Preparative Example 1

### The Preparation of PENA

10 g 4-bromo-1,8-naphthalic anhydride (AR, Anshan Huifeng Chemical Co. Ltd.) recrystalized with xylene (AR, Beijing First Chemical Reagent Plant), 5.5 g (6 ml) phenylacetylene (AR, Sigma Aldrich Co.), 0.01956 g triphenylphosphine (CP, Shanghai First Reagent Plant), 0.0657 cuprous iodide (AR, Sigma Aldrich Co.), 0.0322 g triphenylphosphine palladium dichloride (AR, Sigma Aldrich Co.), 50 ml distilled triethylamine (AR, Tianjin Second Chemical Reagent Plant), 100 ml toluene (AR, Beijing First Chemical Reagent Plant) are added into a 250 ml three necked flask having an inlet of nitrogen gas, a thermometer, mechanical agitation and a reflux condensing pipe. The mixture of reactants is slowly heated with an oil bath pan to reflux for 6.5 hours under continuous nitrogen aeration. Precipitation of yellowish white solid can be observed on the wall of the reaction flask. After cooling and filtration, a yellow solid is obtained. The catalysts and the inorganic salts generated from the reaction are subsequently rinsed off with distilled water, followed by drying at 120° C. for 2 hours and recrystallization with xylene. 13.2 yellow needle of PENA is obtained.

### Preparative Example 2

### Preparation of the Diamine Monomer 1,4-bis(4-amino-2-trifluoromethylphenyloxy)-2-(3′-trifluoromethylphenyl)benzene

1,4-bis(4-amino-2-trifluoromethylphenyloxy)-2-(3′-trifluoromethylphenyl)benzene used in the examples is prepared according to the following scheme with the following specific steps.

Preparation of a dinitro monomer: 0.2 mol (50.84 g) trifluoromethyl bisphenol (prepared according to the method described in Liu B J, Wang G B, Hu W, Jin Y H, Chen C H, Jiang Z H, et al. J Polym Sci Part A Polym Chem 2002; 40:3392), 0.4 mol (90.22 g) 2-chloro-5-nitro-3-trifluorotoluene (AR, Shanghai Wescco Chemical Co. Ltd.), 0.24 mol (33.12 g) anhydrous potassium carbonate (AR, Tianjin Chemical Reagent Plant), 500 ml DMF (AR, Tianjin Tiantai Refine Chemical Co. Ltd.) and 70 ml toluene were added into a 1000 ml three necked flask having mechanical agitation, nitrogen gas inlet, Dean-Stark trap, and a reflux condensing pipe and heated to allow toluene to reflux for 4 hours. The reflux temperature is controlled at 130° C., then the temperature is increased to 150° C. to evaporate off the toluene. The reaction is continued for another 8 hours. The reaction temperature is further controlled at 160˜170V, and the reaction is continued for another 4 hours. Finally, it is discharged into distilled water. After repeated rinsing with ethanol (AR, Beijing Chemical Plant) and deionized water, and drying at 120° C. in an oven for 24 hours, 96.16 g yellow powder of dinitro monomer as shown in the following chemical formula is obtained.

Preparation of the diamine monomer: 0.02 mol (12.65 g) of the thus synthesized dinitro monomer, 0.24 mol (13.44 g) iron powder (AR, Beijing Chemical Reagent Plant), and 60 ml ethanol in water solution with a volume fraction of 50% are placed in a 250 mol three necked flask for refluxing. During the refluxing, 0.704 ml concentrated hydrochloric acid (AR, Beijing Chemical Reagent Plant, 36.5% (volume)) and 10 mL ethanol in water solution with a volume of fraction of 50% are dropwise added. The refluxing reaction is continued for another 3 hours, followed by the addition of 0.366 g NaOH to neutralize the extra unreacted hydrochloric acid. Subsequently, the mixed solution is subject to heat filtration. The filtrate is cooled under nitrogen protection until the diamine monomer precipitates, which is recrystallized with ethanol to obtain 8.5 g of the diamine monomer 1,4-bis(4-amino-2-trifluoromethylphenyloxy)-2-(3′-trifluoromethylphenyl)benzene.

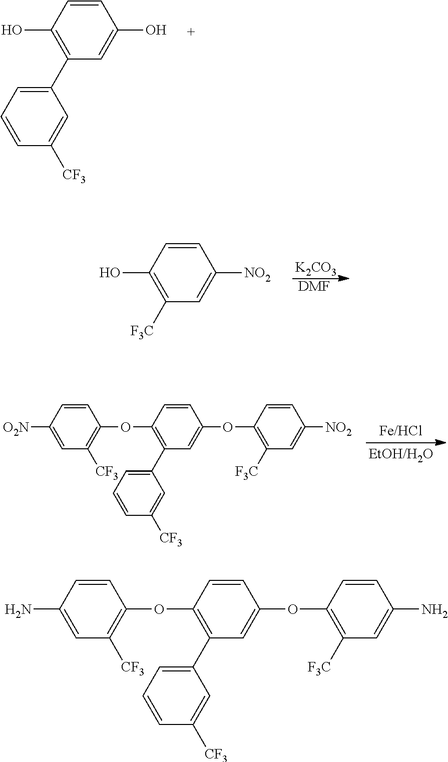

### Example 1

0.4653 g ODPA (AR, Sigma Aldrich Co. Ltd.), 1.1448 g 1,4-bis(4-amino-2-trifluoromethylphenyloxy)-2-(3′-trifluoromethylphenyl)benzene thus prepared, as well as 10 ml m-cresol (AR, Changzhou Xinhua Active Material Co. Ltd.) are added into a 100 ml three necked flask having magnetic stirrer, nitrogen inlet and a reflux condensing pipe and agitated with nitrogen aeration for 10 hours. 0.2983 g capping agent PENA thus prepared and 10 ml xylene (Ar, Beijing First Chemical Reagent Plant) are then added and heated to 160° C. to reflux with water for 3 hours, followed by the addition of 7 ml isoquinoline (Ar, Beijing Lianhua Fine Chemical Co. Ltd.). The temperature is increased to 200° C. to evaporate off xylene and the reaction is continued for 10 hours. After the completion of the reaction, the three necked flask is cooled to the room temperature and its content is slowly poured into absolute ethanol (AR, Beijing Chemical Plant) with thorough agitation to precipitate a yellow pellet. This yellow pellet is rinsed with water several times, followed by suck filtration and drying at 120° C. to yield 1.10 g polyimide prepolymer I with the number of repeating units of 3 (n=3). In regards to the raw material ODPA, 1,4-bis(4-amino-2-trifluoromethylphenyloxy)-2-(3′-trifluoromethylphenyl)benzene and PENA, the yield is 57.6 wt %.

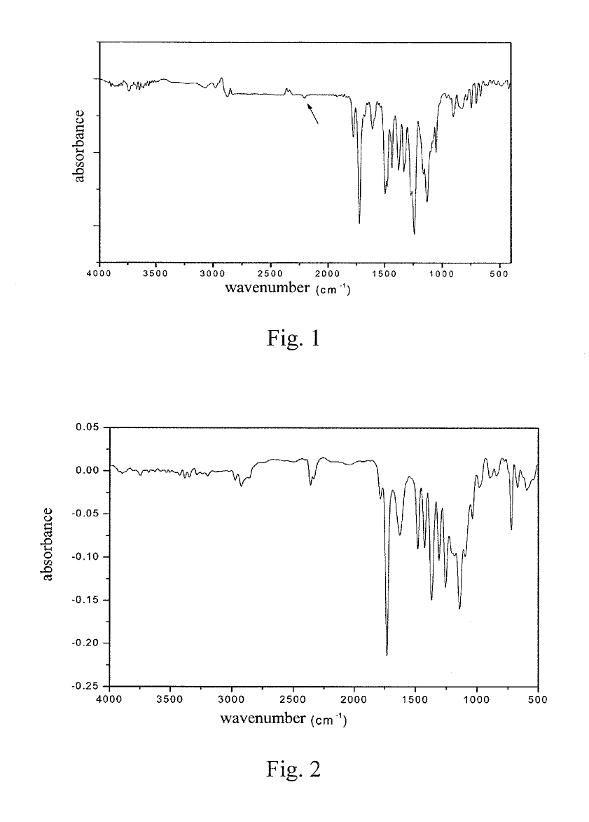

The polyimide prepolymer I thus obtained is subject to infrared analysis (Nicolet Impat 410 Fourier Transformation Infrared Spectrometer), and the result is shown in FIG. 1. The absorption peak at 1780 cm⁻¹ and 1726 cm⁻¹ corresponds to C═O; the absorption peak at 1363 cm⁻¹ corresponds to C—N; the absorption peak at 1320 cm⁻¹ and 1136 cm⁻¹ corresponds to —CF; and the characteristic absorption at 2215 cm⁻¹ proves that the end capping reaction with phenylacetylene is successful. From the figure it can also been found that there is no absorption peak for amino group within the range of 3200-3600cm⁻¹, indicating the ring closing of the polymer is very complete.

0.3 g polyimide prepolymer I is weighted and maintained in a vacuum oven at 350° C. for 2 hours to allow the phenylethynyl group to cross-link. Then the cross-linked and cured sample is placed in a flask having a reflux condensing pipe to be refluxed using N-methylpyrolidone (AR, Tianjin Dengfeng Chemical Reagent Plant) as the solvent at its boiling temperature for 24 hours, then cooled to the room temperature. After filtration, it is further repeatedly washed with N-methylpyrolidone and dried under vacuum to a constant weight. The mass percentage of the remaining sample relative to the initial sample is calculated for the evaluation of its solvent resistance. The higher the mass percentage, the lower dissolving effect of the solvent against the sample. The solvent resistance of this polyimide prepolymer I is 99.6%.

### Example 2

Except for the replacement of the ODPA with equimolar 6FDA as the dianhydride component, other operations are the same as Example 1. 1.16 g polyimide prepolymer II is obtained with the number of the repeating units of 3 (n=3). In regards to the raw material 6FDA, 1,4-bis(4-amino-2-trifluoromethylphenyloxy)-2-(3′-trifluoromethylphenyl)benzene and PENA, the yield is 55.2 wt %.

The polyimide prepolymer II is subjected to infrared analysis. The result is shown in FIG. 2. The solvent resistance is measured as 99.7 wt % using the same method as Example 1.

### Example 3

Except for the replacement of the 0.4653 g ODPA and 1.1448 g 1,4-bis(4-amino-2-trifluoromethylphenyloxy)-2-(3′-trifluoromethylphenyl)benzene with 0.7755 g ODPA and 1.7172 g 1,4-bis(4-amino-2-trifluoromethylphenyloxy)-2-(3′-trifluoromethylphenyl)benzene, other operations are the same as Example 1. 1.74 g polyimide prepolymer III is obtained with the number of the repeating units of 5 (n=5). In regards to the raw material ODPA, 1,4-bis(4-amino-2-trifluoromethylphenyloxy)-2-(3′-trifluoromethylphenyl)benzene and PENA, the yield is 62.3 wt %.

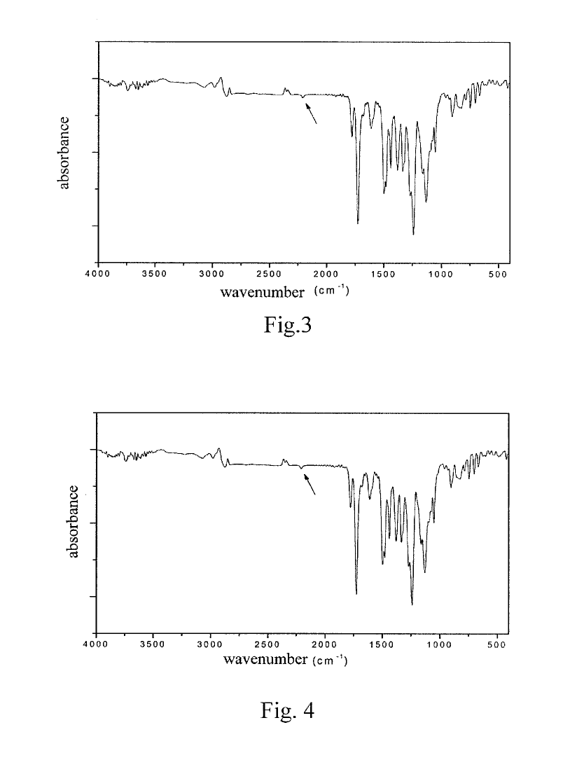

The polyimide prepolymer III is subjected to infrared analysis. The result is shown in FIG. 3. The solvent resistance is measured as 99.6 wt % using the same method as Example 1.

### Example 3

Except for the replacement of the 0.4653 g ODPA and 1.1448 g 1,4-bis(4-amino-2-trifluoromethylphenyloxy)-2-(3′-trifluoromethylphenyl)benzene with 0.7755 g ODPA and 1.7172 g 1,4-bis(4-amino-2-trifluoromethylphenyloxy)-2-(3′-trifluoromethylphenyl)benzene, other operations are the same as Example 1. 1.74 g polyimide prepolymer III is obtained with the number of the repeating units of 5 (n=5). In regards to the raw material ODPA, 1,4-bis(4-amino-2-trifluoromethylphenyloxy)-2-(3′-trifluoromethylphenyl)benzene and PENA, the yield is 62.3 wt %.

The polyimide prepolymer III is subjected to infrared analysis. The result is shown in FIG. 3. The solvent resistance is measured as 99.6 wt % using the same method as Example 1.

### Example 4

Except for the replacement of the 0.4653 g ODPA and 1.1448 g 1,4-bis(4-amino-2-trifluoromethylphenyloxy)-2-(3′-trifluoromethylphenyl)benzene with 1.2408 g ODPA and 2.5758 g 1,4-bis(4-amino-2-trifluoromethylphenyloxy)-2-(3′-trifluoromethylphenyl)benzene, other operations are the same as Example 1. 2.46 g polyimide prepolymer IV is obtained with the number of the repeating units of 8 (n=8). In regards to the raw material ODPA, 1,4-bis(4-amino-2-trifluoromethylphenyloxy)-2-(3′-trifluoromethylphenyebenzene and PENA, the yield is 59.7 wt %.

The polyimide prepolymer IV is subjected to infrared analysis. The result is shown in FIG. 4. The solvent resistance is measured as 99.3 wt % using the same method as Example 1.

### Comparative Example 1

Except for the replacement of the 0.4653 g ODPA and 1.1448 g 1,4-bis(4-amino-2-trifluoromethylphenyloxy)-2-(3′-trifluoromethylphenyl)benzene with 1.5510 g ODPA and 3.1482 g 1,4-bis(4-amino-2-trifluoromethylphenyloxy)-2-(3′-trifluoromethylphenyl)benzene, other operations are the same as Example 1. 2.5 g polyimide prepolymer V is obtained with the number of the repeating units of 10 (n=10). In regards to the raw material ODPA, 1,4-bis(4-amino-2-trifluoromethylphenyloxy)-2-(3′-trifluoromethylphenyl)benzene and PENA, the yield is 50 wt %. Its infrared spectrum is similar to those of the polyimide prepolymers in the aforementioned examples. The solvent resistance is measured as 92.3 wt % using the same method as Example 1.

### Comparative Example 2

Except for the replacement of the 0.4653 g ODPA and 1.1448 g 1,4-bis(4-amino-2-trifluoromethylphenyloxy)-2-(3′-trifluoromethylphenyl)benzene with 1.8612 g ODPA and 3.7206 g 1,4-bis(4-amino-2-trifluoromethylphenyloxy)-2-(3′-trifluoromethylphenyl)benzene, other operations are the same as Example 1. 2.76 g polyimide prepolymer VI is obtained with the number of the repeating units of 12 (n=12). In regards to the raw material ODPA, 1,4-bis(4-amino-2-trifluoromethylphenyloxy)-2-(3′-trifluoromethylphenyebenzene and PENA, the yield is 46.9 wt %. Its infrared spectrum is similar to those of the polyimide prepolymers in the aforementioned examples. The solvent resistance is measured as 90 wt % using the same method as Example 1.

### Comparative Example 3

Except for the replacement of the 0.4653 g ODPA and 1.1448 g 1,4-bis(4-amino-2-trifluoromethylphenyloxy)-2-(3′-trifluoromethylphenyebenzene with 0.3102 g ODPA and 0.8586 g 1,4-bis(4-amino-2-trifluoromethylphenyloxy)-2-(3′-trifluoromethylphenyl)benzene, other operations are the same as Example 1. 0.55 g polyimide prepolymer VII is obtained with the number of the repeating units of 2 (n=2). In regards to the raw material ODPA, 1,4-bis(4-amino-2-trifluoromethylphenyloxy)-2-(3′-trifluoromethylphenyebenzene and PENA, the yield is 37.4%. Its infrared spectrum is similar to those of the polyimide prepolymers in the aforementioned examples. The solvent resistance is measured as 68 wt % using the same method as Example 1.

### Example 5

### Film Forming Capacity

1 g polyimide prepolymers of Examples 1-4 and Comparative Examples 1-3 are individually prepared, dissolved in 10 ml DMAc (AR, Tianjin Tiantai Refine Chemical Co. Ltd.), and agitated until it is completely dissolved to obtain the polyimide prepolymer dispersion. The polyimide prepolymer dispersion is coated onto clean glass substrates (10 cm×10 cm) by spin coating (MTI Spin coating, Model VTC-100, parameter of the spin coating: 1000 rpm). In a vacuum oven, the temperature is increased stepwise to 180° C. (heating at 40° C. 80° C., 100° C., 120° C. and 140° C. for 1 hour, respectively, heating at 150° C. for 30 minutes, finally heating to 180° C.) to remove the solvent and form the film. After the film formed is observed, it is again placed into the vacuum oven and cured and cross-linked at 350° C., vacuum for 2 hours to provide the cross-linked and cured alignment film with a thickness of 44 μm.

Among them, the polyimide prepolymer of Examples 1-4 is easy to be coated and form film, thus they have good film forming capacity. For the film forming of the polyimide prepolymer of Comparative Examples 1 and 2, it appears that the films have uneven thickness and impurities, etc. For the film forming of the polyimide prepolymer of Comparative Example 3, it appears that the film is impossible to form or easy to break, thus it has poor film forming capacity.

### Example 6

### Test of Pretilt Angle

First, a liquid crystal simulation element is made: two 3 cm×3 cm pieces are cut from the glass substrates with the alignment films formed from the polyimide prepolymer of Examples 1-4 prepared in Example 5, and their alignment films are subjected to parallel rubbing in the same direction with a rubbing machine (Rubbing Machine Model M-2000, Hebei Xuanhua Testing Machine Plant). Subsequently, the two pieces of glass plates are formed into a box by way of making the alignment films facing each other and binding with frame sealing (Model S-WB21, Sekisui Chemical) along three sides of the glass substrates. The frame sealing had previously been cured with UV (ultraviolet light) for 60 seconds, then heat cured at 120° C. for 1 hour to ensure that the frame sealing thoroughly stick the two glass substrates together. Finally, 0.03 mg liquid crystal (Model MAT-09-1284, Merck Liquid Crystals Co.) are injected in and the box is sealed with a small amount of frame sealing. The aforementioned steps of curing the frame sealing are repeated. A complete liquid crystal simulation element suitable for test is made.

The individual liquid crystal simulation elements obtained are subject to pretilt angle tests with a Model PAT20 pretilt angle testing machine (Changchun Lianchun Instrument Co. Ltd.) (error of measurement of ±0.1°). Their pretilt angles are 0.9°, 1.1°, 1.5°, and 1.2°, respectively, showing great improvement over the pretilt angle of 2˜5° of the traditional STN type polyimide alignment film.

1. A polyimide prepolymer, comprising a repeating unit as shown in Formula (1) and being capped with a capping agent having a phenylethynyl group: 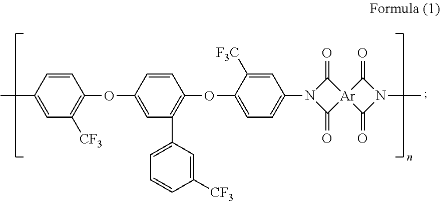
wherein Ar is selected from one of the structures of the following Formulae (2) and (3); 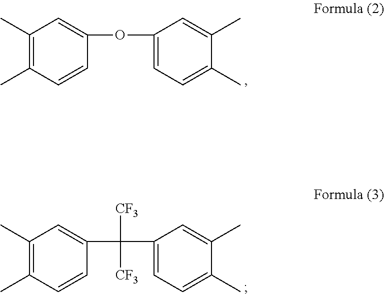
and n is an integer of between 3 and 8.

2. The polyimide prepolymer according to claim 1, wherein the capping agent having a phenylethynyl group is 4-phenylethynyl-1,8-naphthalic anhydride.

3. The polyimide prepolymer according to claim 1, wherein the polyimide prepolymer is 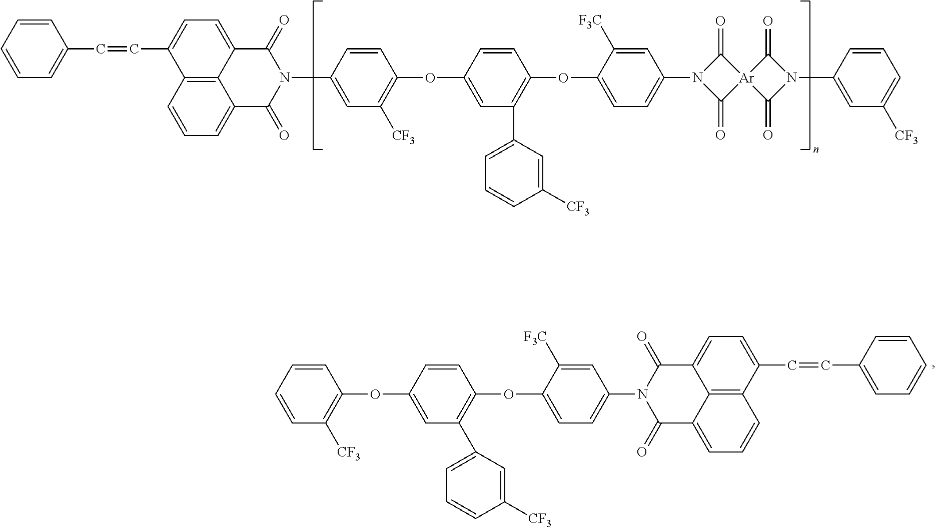
wherein Ar is selected from one of the structures of the Formulae (2) and (3), and n is 3, 5 or 8.

4. The polyimide prepolymer according to claim 3, wherein Ar is selected from the structure of Formula (3).

5. An alignment film comprising a polyimide prepolymer according to claim 1.

6. The alignment film according to claim 5, wherein it has a pretilt angle of between 0° and 2°.

7. The alignment film according to claim 6, wherein it has a pretilt angle of between 0.5° and 1.5°.

8. A method for preparing an alignment film, comprising the steps of:
1) dissolving a polyimide prepolymer according to any one of claims 1 to 4 in an organic solvent, agitating to be homogeneous, and then spreading the obtained solution onto a glass substrate, drying to removing the solvent so as to form a film; and
2) heating to a temperature of between 350° C. and 400° C. to cross-link phenylethynyl groups.

9. A liquid crystal display device comprising a color film substrate and an array substrate, wherein the device comprises an alignment film according to claim 5.

10. The liquid crystal display device according to claim 9, wherein a pixel electrode and a common electrode are disposed on the array substrate, wherein the pixel electrode and the common electrode are disposed in different layers of the array substrate, and an insulating layer is provided between the pixel electrode and the common electrode, the common electrode covers the whole pixel area, and the pixel electrode has a shape of a slit.
